(19) United States
(12) Patent Application Publication
(10) Pub. No.: US 2015/0311649 A1
(43) Pub. Date: Oct. 29, 2015

(54) METHOD AND SYSTEM TO AUTOMATICALLY IDENTIFY ELECTRICAL DEVICES

(71) Applicant: Red Point Positioning Corporation, Brookline, MA (US)

(72) Inventors: Jonathan E. Horne, Boulder, CO (US); Jun Zhang, Beijing (CN); Chunjie Duan, Brookline, MA (US); Pawel Osiczko, Boulder, CO (US); Georgiy Pekhteryev, Kharkiv (UA)

(21) Appl. No.: 14/689,277

(22) Filed: Apr. 17, 2015

Related U.S. Application Data
(60) Provisional application No. 61/983,320, filed on Apr. 23, 2014.

(51) Int. Cl. H01R 13/66; H01R 25/00

(52) U.S. Cl. CPC H01R 13/6691; H01R 25/003

(57) ABSTRACT

Systems and methods provide for the transmission of identification information from an electronic device through its power cable. The device can be outfitted with a power cable that has an electronically encoded identifier that it can transmit. A power-strip can includes a separate receiver for each available outlet that can read the power-cable's electronic identifier when it is plugged in. Optionally, the identification information and the location of the power cable can be transmitted to a server or other device.

### CROSS-REFERENCE TO RELATED APPLICATIONS

This application claims priority to U.S. Provisional Application No. 61/983,320, filed on Apr. 23, 2014, which is hereby incorporated herein by reference in its entirety.

### FIELD OF THE INVENTION

This invention relates to the automatic self-identification of power cables and associated devices and connectors using electronically encoded and communicated identifiers. This invention has broad applicability to any device that is powered from an external source.

### BACKGROUND OF THE INVENTION

Electrical and electronic equipment that is powered by an external source is typically connected to an electricity source via a power cable. While these devices can exist in isolation, it is very common for such devices to be collocated. An example application in the home or office might be a computer workstation with various peripherals connected to a power-strip, collectively using a small number of power cables. At the other extreme, an enterprise application might require hundreds of racks of computer servers, powered by thousands of power cables connected to power-strips. Identifying which cable powers which device can be problematic, especially as the number of cables grows. The cables are often clustered together and visually indistinguishable, offering no indication as to which device is powered by which cable. In the enterprise example, it is often critical that a single device be disconnected without removing power from other devices.

In many applications, it is necessary to associate a device to a location in the power network. Being able to identify the device is plugged into a given socket, or conversely, to determine which socket a given device is plugged in. As an example, to improve energy efficiency of a home, it is necessary for the system to have the knowledge of a given appliance in a given device such that its behavior can be analyzed and its operation can be controlled accordingly. Unfortunately, an appliance can be plugged into any one of the sockets and it is often difficult to determine where the appliance is plugged in. An appliance may be moved from one socket and plugged into a different socket. Therefore, it is necessary that the location information of a given device be updated automatically.

There are already existing methods for communication between a device and the power network. Wireless technology such as WiFi and ZigBee can be used. The Power Line Communication (PLC) technology can also be used. There are already products available based on the aforementioned technologies. However, all these technologies face the challenge that the location of the communication node cannot be determined because of the location ambiguity caused by the crosstalk of the signals.

There already exist power strips that are capable of communicating with a centralized computer, used for such functions as switching and measuring power consumption of connected devices. There is, however, a need for a simple means for identifying which device is plugged into which socket of the power strip, and therefore an automated means for knowing which device is to be switched or measured.

### SUMMARY OF THE INVENTION

Systems and methods of the invention transmit information of an electrical device to the power network and subsequently allow the system to associate the location in an electric power network to a device.

In certain embodiments, the invention provides a system for automatically identifying the power source for a given device. The device is outfitted with a power cable that has an electronically encoded identifier that is transmitted. A power-strip includes a separate receiver for each available outlet that can read the power-cable's electronic identifier when it is plugged in.

### BRIEF DESCRIPTION OF THE DRAWINGS

FIG. 1 illustrates the problem of connecting multiple collocated devices to a common power strip, in this embodiment, cables are bundled together, making them hard to identify visually;

FIG. 2 depicts the disclosed optoelectronic communications circuitry embedded in a power strip and power cord;

FIG. 3a shows a simplified circuit diagram for the optical receiver embedded in the power strip described in this disclosure;

FIG. 3b shows a simplified circuit diagram for the optical receiver and transmitter embedded in the power plug described in this disclosure;

FIG. 4 shows a simplified circuit diagram for an optical transmitter with computer interface used to program the unique identifier into the power plug;

FIG. 5 illustrates a programming system for use with the invention; and

FIG. 6 illustrates an optical packet structure for use with the invention.

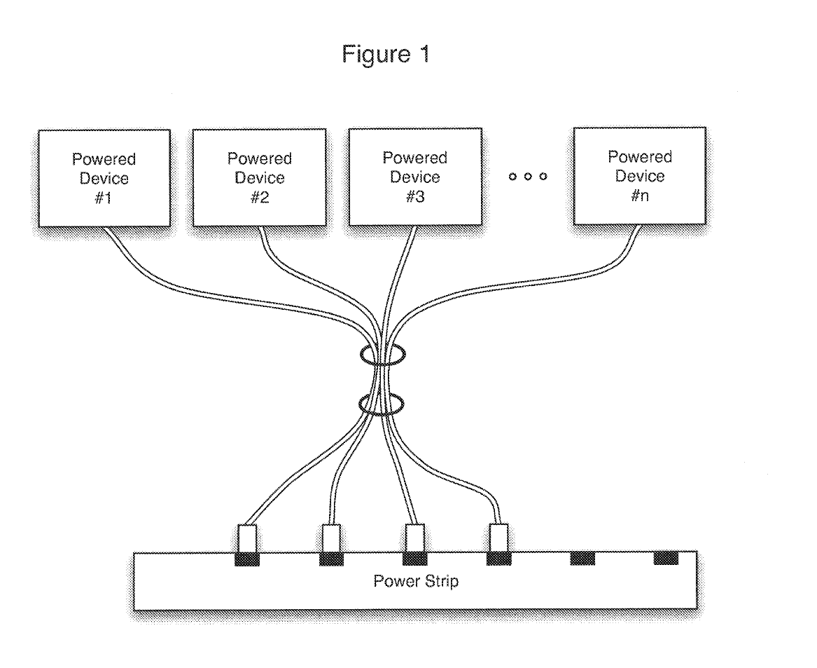

### DETAILED DESCRIPTION OF THE EMBODIMENTS

The disclosed invention spans two physically separate devices that together form an optical communication mechanism that enables the identification and location of connected cables. A third device can be used for programming of the power cable's unique identifier.

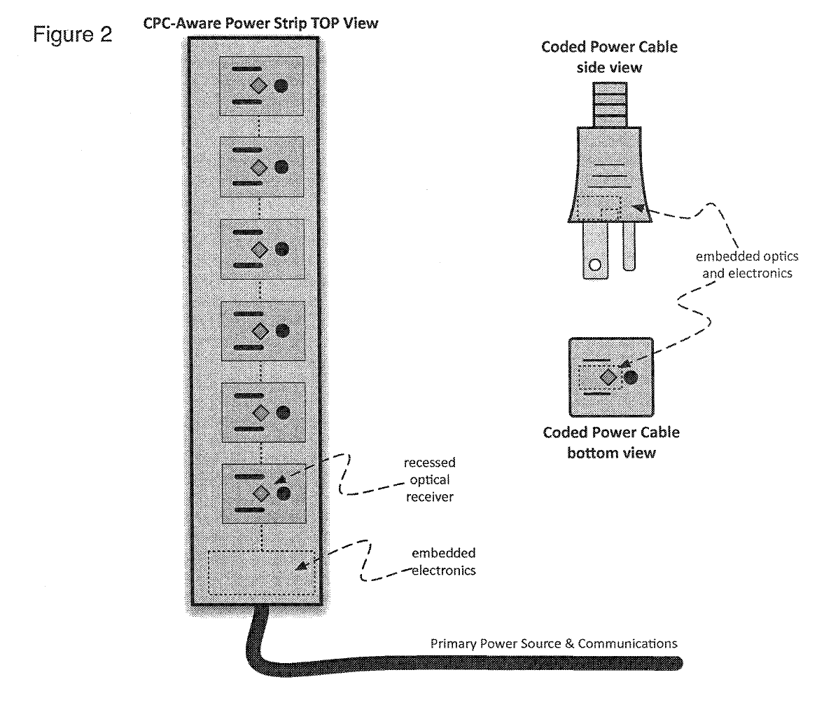

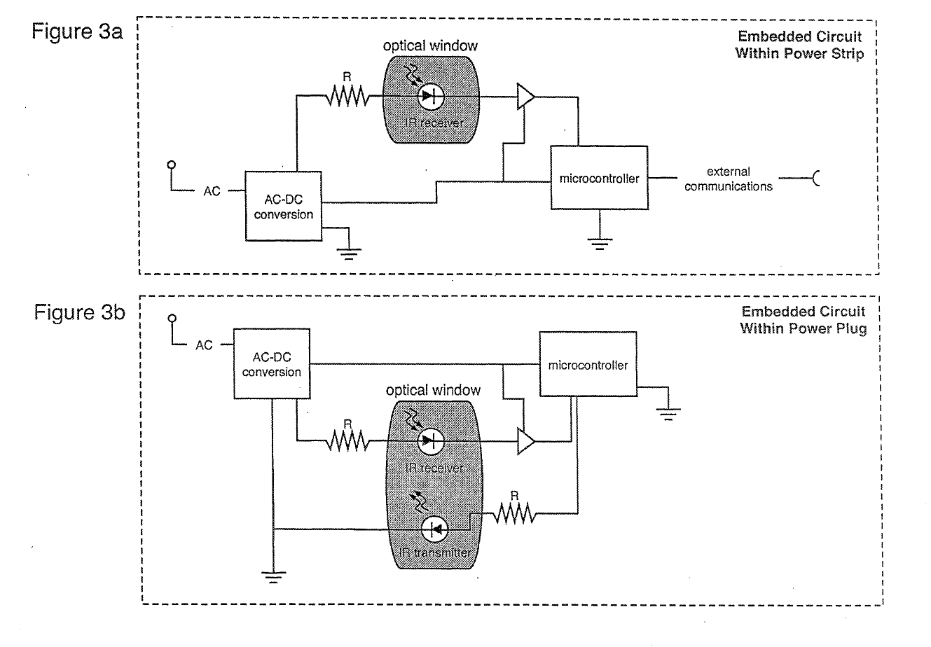

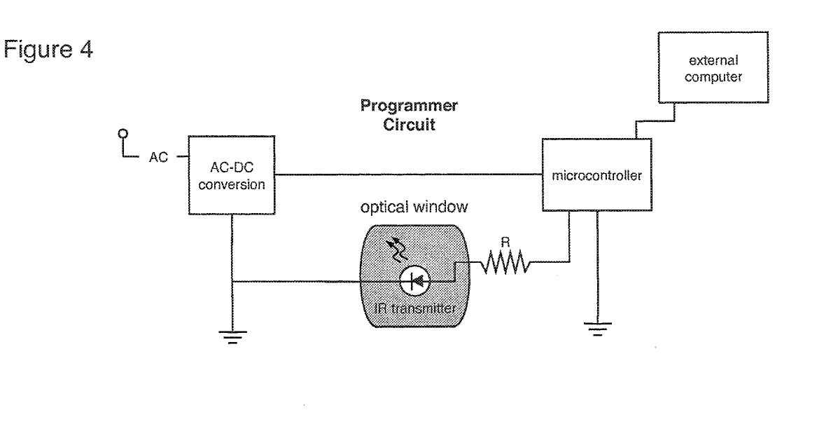

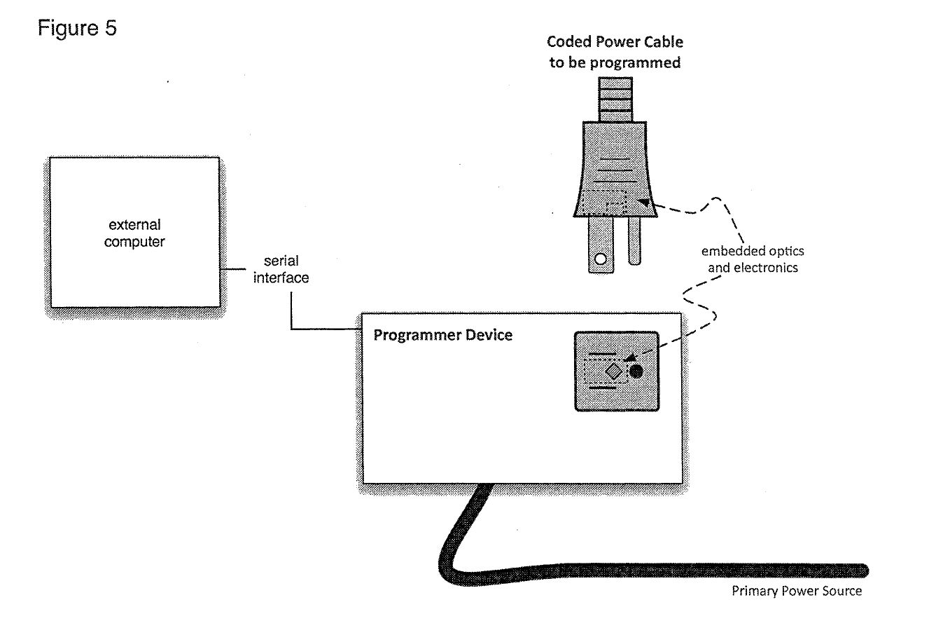

The first device can be a power cable, as shown in FIG. 2. The power cable can have the capability of transmitting a unique, coded identifier through an optical window. The illustrated cable contains a circuit like the one shown in FIG. 3b and is referred to in this disclosure as a Coded Power Cable (CPC). The circuitry and optical transceiver may be embedded in the cable itself, or may be embedded in a separate module that connects to an existing cable.

The second device receives the power cable and can be a mating power strip such as the one shown in FIG. 2, or a power socket installed in the wall. The second device can contain an optical receiver and a circuit like that shown in FIG. 3a. This enhanced power strip is referred to in this document as a CPC-Aware Power Source (CAPS). The CAPS normally provides communication with an external server via WiFi, Ethernet, or some other known means as networked power-strips are available in the art. The CAPS disclosed herein, however, provides for optical communication between the CPC and the CAPS.

In the illustrated embodiment, a power consuming device is fitted with a CPC and plugged into a CAPS power strip. When power is applied to the CPC, it begins periodically transmitting its unique code using optical pulses directed through its translucent window. Using the optical receivers and associated hardware embedded in the CAPS, each of the CPCs plugged into the power strip can be uniquely identified by its code and its location optionally relayed to a server or other device.

Circuit Details

Caps

An exemplary circuit for use in the CAPS is illustrated in FIG. 3a. This circuit is designed to receive and decode optical pulses observed through its window. The circuit rectifies the AC main power and converts it to a low-voltage DC source that is used to power an optical receiver, operational amplifier, and a microcontroller. The receiver is an optical transistor or diode that is gated by infrared light. When light hits the semiconductor device, it enables current to flow. The current is amplified to ensure switching at logic levels, and is routed to a microcontroller. The microcontroller is responsible for measuring the incoming voltage level and decoding the pulse stream.

CPC

An exemplary circuit for use in the CPC is illustrated in FIG. 3b. This circuit can be a superset of that included in the CAPS, having both a receiver and a transmitter.

The CPC can include an optical receiver that functions identically to that in the CAPS. The purpose of the receiver in the CAPS, however, is to provide initial programming of the power cord's unique identifier. The CPC receiver circuit receives pulses from the programmer, discussed, in the next section, and stores the decoded identifier into its non-volatile storage.

The CPC can also include an optical transmitter. Under control of the microcontroller, the transmitter will periodically send a coded version of its unique identifier. It does this by pulsing its infrared LED.

Programmer

The programmer is a device that is used to set the unique identifier contained within a CPC. Physically, the programmer can include an AC power socket, like the ones contained in the CAPS, but instead of enclosing an optical receiver, it encloses an optical transmitter. The circuitry can be the same as the transmitter circuit contained within the CPC with the addition of an interface to an external computer. A user can then use an external computer to direct the programmer device to transmit a coded sequence that contains within it the unique identifier to be assigned to the CPC.

Embedded Application Code

The microcontroller embedded in the CPC can decode received packets in the same way as the CAPS. If it receives a packet instructing it to program the unique identifier, it can record this and store it in non-volatile memory.

Received packets can be verified for correctness by verifying that the transmitted cyclic-redundancy-check (CRC) matches the computed CRC for the received bits. Beyond receiving, the CPC must also periodically transmit the stored identifier. It does this either with hardware assistance using the microcontroller's UART, or by writing directly to one of the microcontroller's output pins.

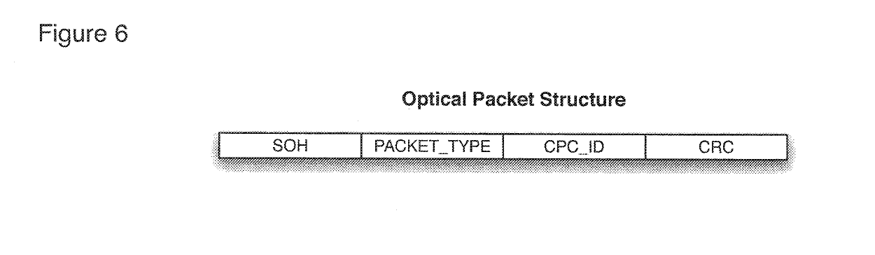

The microcontroller contained within the programmer device receives a “program” command from the external PC via a serial interface that includes a unique identifier, and then begins to transmit the specified identifier using a “program” packet structure, such as the one shown in FIG. 6.

Optical Packet Structure

The optical transmitter can send pulses in a specific format so that the receiver may properly recognize them. The following embodiment is one possible format, though the packet structure could take a variety of different formats. The transmitted packets may include the fields described in the following table:

| | Field | |
|---|---|---|
| | Length | |
| Field Name | (bits) | Description |
| SOH | 32 | Start-Of-Header. This sequence of bits |
| | | indicates the start of a new packet. |
| | | The sequence is 32 alternating bits |
| | | [1010 . . . 10] starting with 1. |
| PACKET_TYPE | 2 | Two bits indicate whether the transmitted |
| | | sequence is to program a CPC, or to |
| | | identify a CPC to a CAPS |
| | | [01] → Program |
| | | [10] → Identify |
| CPC_ID | 32 | These 32 bits contain the unique identifier |
| | | for the CPC |
| CRC | 16 | A 16-bit cyclic redundancy check over the |
| | | PACKET_TYPE and CPC_ID fields. |

The disclosed invention can provide a way to identify devices and their associated connections. This facilitates device automation as well as manual identification. The disclosed method provides reliable and cost-effective communication for use across a broad range of applications.

Although the invention has been described by way of examples of preferred embodiments, it is to be understood that various adaptations and modifications may be made within the spirit of the scope of the invention. Therefore, it is the object of the appended claims to cover all such variations and modifications as come within the true spirit and scope of the invention.

1. A system for identifying a power consuming device comprising:
a power plug having at least two prongs for receiving electrical power from an outlet, the power plug including an optical transmitter and a processor, the processor being configured to cause the optical transmitter to transmit an identification code for the power plug; and
a power receptacle having at least two sockets corresponding to the at least two prongs for delivering electrical power to the power plug, the power receptacle including an optical receiver, wherein the optical receiver is located so that when the prongs are engaged with the sockets, the optical receiver may receive transmissions from the optical transmitter;
wherein when the prongs are electrically connected to the sockets, power is supplied to the processor and optical transmitter and the optical transmitter transmits the identification code to the optical receiver.

2. The system of claim 1, wherein the power receptacle further includes a networking element for transmitting an identification of the power plug across a computer network.

3. The system of claim 2, wherein a plurality of power receptacles are provided on a power strip having the networking element.

4. The system of claim 1, wherein the optical transmission consists of a plurality of optical pulses.

5. The system of claim 1, wherein the receptacle includes a circuit that rectifies AC power provided by the receptacle and converts it to a low voltage DC source that powers the optical receiver.

6. The system of claim 5, wherein the receptacle further includes a microcontroller that is configured to decode the optical transmission.

7. The system of claim 6, wherein the optical receiver comprises an optical semiconductor that allows current to flow when light from the optical transmission impacts the semiconductor, the current being electrically provided to the microcontroller.

8. The system of claim 4, wherein the power plug includes a circuit that rectifies AC power provided by the receptacle and converts it to a low voltage DC source that powers the optical transmitter.

9. The system of claim 8, wherein the optical transmitter comprises an infrared LED.

10. The system of claim 8, wherein the processor is configured to cause the optical transmitter to periodically transmit the identification code of the power plug.

11. The system of claim 1, further comprising an optical receiver in the power plug.

12. The system of claim 11, further comprising a programmer having a processor and an optical transmitter, the programmer being configured to transmit using its optical transmitter to the optical receiver of the power plug a unique identification code for the power plug, the power plug processor being configured to receive the unique identification code from the optical receiver and to store the unique identification code in a non-volatile memory in the power plug.
